(19) United States
(12) Patent Application Publication
(10) Pub. No.: US 2026/0136296 A1
(43) Pub. Date: May 14, 2026

(54) RADIO UNIT AND METHODS IN A WIRELESS COMMUNICATIONS NETWORK

(71) Applicant: Telefonaktiebolaget LM Ericsson (publ), Stockholm (SE)

(72) Inventors: Swapnil JAIN, Staffanstorp (SE); Rupesh Kumar THAKUR, Lund (SE)

(21) Appl. No.: 19/118,010

(22) PCT Filed: Oct. 4, 2022
(86) PCT No.: PCT/SE2022/050885

§ 371 Date: Apr. 3, 2025

(51) Int. Cl. H04W 52/02; H04B 7/06

(52) U.S. Cl. CPC H04W 52/028; H04B 7/0695; H04W 52/0206; H04W 52/0248

(57) ABSTRACT

A method performed by a Radio Unit, RU is provided. The method is for handling energy saving in antenna branches related to the RU. The RU operates in an Open Radio Access Network, ORAN, of a wireless communications network. The RU receives (202) a Control, C, plane message from a Distributed Unit, DU, The C plane message relates to a data stream scheduled for a slot in the ORAN. The RU derives (203) parameters from the C-plane message. The derived parameters comprise the start symbol and the number of symbols schedueled for each respective antenna branch for the slot, and the start Physical Resource Block, PRB, and the number of PRBs scheduled on each symbol in the slot. The RU then decides (204) how to handle energy saving in the antenna branches associated with the slot, based on the derived parameters.

### TECHNICAL FIELD

Embodiments herein relate to a Radio Unit (RU) and methods therein. In some aspects, they relate to handling energy saving in antenna branches related to the RU operating in an Open Radio Access Network (ORAN) of a wireless communications network.

Embodiments herein further relates to a computer program and a carrier corresponding to the above method and RU.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2(FR2 ). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

ORAN is a non-proprietary version of the RAN system that allows interoperation between cellular network equipment provided by different vendors.

A Radio Unit (RU) e.g. handles a digital front end and parts of the Physical (PHY) layer, as well as digital beamforming functionality.

A Distributed Unit (DU), e.g. a DU software, is normally deployed close to the RU on site. It may run the Radio Link Control (RLC), Medium Access Control (MAC), and parts of the PHY layer.

In ORAN a DU and a RU may thus be of different vendors. In order to have a standard communication between DU and RU of different vendors, an ORAN interface has been defined. There are different types of message planes in ORAN for communication between a DU and a RU over the ORAN interface.

One category is Management (M)-plane and Synchronization (S)-plane for performing the setup. Another category is Control (C)-plane and User (U)-plane for transporting the data. A C-Plane message carries control information, e.g., the number of symbols, the number of Physical Resource Blocks (PRB)s, a beam identifier etc., to define a structure of expected U-plane data. A U-plane message carries the In-band and Quadrature (IQ) data and the decoding information.

### SUMMARY

As a part of developing embodiments herein a problem was identified by the inventors and will first be discussed.

In case of proprietary interface between the DU and the RU, a vender can add parameters for power efficiency. However, ORAN has a standard interface for the C and U-plane messages that does not have fields to explicitly enable power saving on slot/symbol basis. Thus, a DU cannot guide an RU about power saving functionality using the ORAN interface.

An object of embodiments herein is to improve power saving for an RU operating in an ORAN of a wireless communications network.

According to an aspect of embodiments herein, the object is achieved by a method performed by a Radio Unit, RU. The method is for handling energy saving in antenna branches related to the RU. The RU operates in an Open Radio Access Network, ORAN, of a wireless communications network.

The RU receives a Control, C, plane message from a Distributed Unit, DU. The C plane message relates to a data stream scheduled for a slot in the ORAN.

The RU derives parameters from the C-plane message. The derived parameters comprise a start symbol and the number of symbols scheduled for each respective antenna branch for the slot, and a start Physical Resource Block, PRB, and the number of PRBs scheduled on each symbol in the slot.

The RU then decides how to handle energy saving in the antenna branches associated with the slot, based on the derived parameters.

According to another aspect of embodiments herein, the object is achieved by a Radio Unit, RU, configured to handle energy saving in antenna branches related to the RU. The RU is operable in an Open Radio Access Network, ORAN of a wireless communications network. The RU is further configured to:
Receive a Control, C, plane message from a Distributed Unit, DU, which C plane message is adapted to relate to a data stream scheduled for a slot in the ORAN,
derive parameters from the C-plane message, which derived parameters are adapted to comprise: the start symbol and the number of symbols adapted to be scheduled for each respective antenna branch for the slot, and the start Physical Resource Block, PRB, and the number of PRBs adapted to be scheduled on each symbol in the slot, and
decide how to handle energy saving in the antenna branches associated with the slot, based on the derived parameters.

By inspecting the parameters derived from the C-plane message, the RU is capable of save energy by identifying antenna branches that are appropriate for muting in the symbol(s) in a slot.

Embodiments herein e.g., provide the following advantages:

Even if a DU does not support any power saving functionality, the RU is capable of independently perform power saving.

No explicit signaling and/or fields between the DU and the RU is required to perform the power saving.

In future releases, there may be new power saving functionalities in place but with embodiments herein, radios on older version, which cannot support the newly added features, may still perform power saving according to embodiments herein.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting an embodiment of a method in an RU.

FIG. 3 is a flowchart depicting an embodiment of a method.

FIG. 4 is schematic block diagram illustrating embodiments of a radio unit.

FIG. 5 schematically illustrates a telecommunication network connected via an intermediate network to a host computer.

FIG. 6 is a generalized block diagram of a host computer communicating via a base station with a user equipment over a partially wireless connection.

FIGS. 7-10 are flowcharts illustrating methods implemented in a communication system including a host computer, a base station, and a user equipment.

FIG. 11 schematically illustrates a telecommunication network including one or more ORAN network nodes connected via an intermediate network to a host computer.

### DETAILED DESCRIPTION

Examples of embodiments herein relate to methods in an RU to perform energy saving in ORAN based on a current slot configuration. A current slot configuration when used herein e.g., means that a slot is configured a number of parameters. These parameters are included in a C-plane message sent from a DU to the RU.

In embodiments herein a RU combines some parameters in existing fields in a C-plane message for a slot, to trigger power saving on selected antenna branches. The power saving may be performed by muting, e.g. by deactivating the circuit of that antenna branch in a particular slot/symbol. These parameters may e.g. be startSymbolId, numberOfSections, symInc, startPrbc, numPrbc, numSymbol, beamId. These parameters will be described more in detail below.

This way of muting antenna branches by using C plane message content may be used for both Uplink (UL) and Downlink (DL) direction.

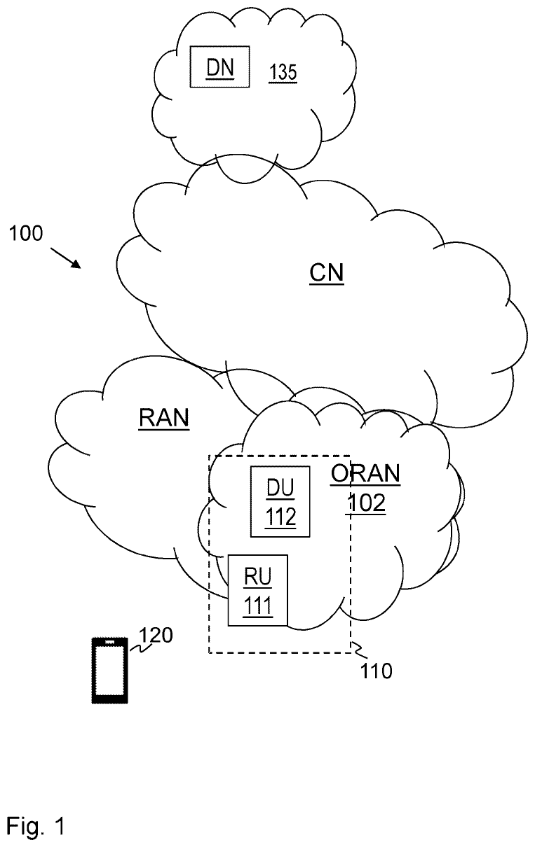

FIG. 1 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations. An ORAN 102 may e.g. be comprised in the wireless communications network 100.

Network nodes, such as a network node 110, operate in the wireless communications network 100. An RU 111 and a DU 112 operates in the wireless communications network 100. The RU 111 and a DU 112 may e.g. be a part of, be comprised in or have access to the network node 110.

An RU 111 operates in the wireless communications network 100. The RU 111 may e.g. be a part of, be comprised in or have access to the network node 110. The RU 111 comprises a number of antenna branches. The RU 111 may e.g., be a radio hardware unit that coverts radio signals sent to and from an antenna into a digital signal for transmission over packet networks, such as e.g. the ORAN 102. It may support digital beamforming functionality.

A DU 112 operates in the wireless communications network 100. The DU 112 may e.g. be a part of, be comprised in or have access to the network node 110. The DU 112 may e.g., be a distributed unit software that is deployed on the network node 110 site. The DU 112 software may preferably be deployed close to the RU 111 and may run Radio Link Contol (RLC), Medium Access Control (MAC), and parts of the Physical (PHY) layer.

The RU 111 and the DU 112 operates together e.g., as a part of the network node 110. The network node 110, e.g. by means of the RU 111 and the DU 112, provides a number of cells and may use these cells for communicating with UEs such as e.g. a UE 120. The network node 110 e.g. comprising the RU 111 and the DU 112, may be a transmission and reception point e.g. a network node, a radio access network node such as a base station, a radio base station, a NodeB, an evolved Node B (eNB, eNodeB, eNode B), an NR/g Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the RU 111 depending e.g. on the radio access technology and terminology used.

UEs operate in the wireless communications network 100, such as e.g. the UE 120. The UE 120 may e.g. be an NR device, a mobile station, a wireless terminal, an NB-IOT device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, and a Vehicle-to-Network (V2N) device, a Wi-Fi device, an LTE device and a non-access point (non-AP) STA, a STA, that communicates via a base station such as e.g. the network node 110, one or more Access Networks (AN), e.g. RAN and/or the ORAN 102, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

Methods herein may in one aspect be performed by the RU 111. As an alternative, a Distributed Node (DN) and functionality, e.g. comprised in a cloud 135 as shown in FIG. 1, may be used for performing or partly performing the methods of embodiments herein.

A C-plane message according to embodiments herein may e.g. comprise and/or indicate the following parameters for a slot. The parameters may relate to a configuration of the slot.

### Start Symbol Identifier (startSymbolId), and the Number of Symbols (numSymbol)

The start symbol and the number of symbols provide the specific symbols scheduled for a particular antenna branch in a slot.

### Start PRB (startPrbc), the Number of PRBs (numPrbc)

The start PRB and the number the number of PRBs provide the number of PRBs on each symbol in the slot.

In the ORAN specification, startPrbc and NumPrbc specify the scheduling in frequency domain and startSymbolid and numSymbol specify the scheduling on the time domain.

### Beam Identifier (beamId)

The beam identifier, also referred to as a beam identifying parameter, maps to a specific Beam weight (beamWeight) table that may be present at the RU 111. This table at the RU 111 has the Beam weights associated for each antenna branch associated with the RU 111.

### The Number of Sections (numberOfSections)

This parameter relates to the number of sections in a slot. A slot comprises a number of sections. The aim of this is that if the information of scheduled PRBs in a symbol is scattered across section(s). Thus, there will be a need to consolidate the information by reading all the sections to derive the information of all the scheduled PRBs in a symbol in a slot.

### Symbol Increment Step (symInc)

Consider the following example for explaining the symbol increment step. If the figure identifying the start symbol is 0, the number of symbols is 4, and symbol increment step is 2, then a C-plane signal will comprise information for symbol 0, 2, 4, 6.

The Symbol Increment step parameter may be used in embodiments here in to identify scheduled symbol in a slot.

According to an example of embodiments herein, the RU 111 uses parameters received from the DU 112 in a C-plane message relating to a specific slot of a data stream in the ORAN 102. These parameters comprise at least the start symbol and the number of symbols of a slot and the start PRB and the number of PRBs on the specific slot.

This parameter information provides the specific symbols scheduled for a particular antenna branch in a slot and the number of PRBs on each symbol. Based on this, the RU 111 is enabled handle energy saving by deciding whether or not an antenna branch shall be muted, e.g. if a circuit of an antenna branch may be switched off or not, for one or more symbols or for all of symbols in the slot. In this way, the antenna branches will be muted for the symbols where there is no PRB scheduled in the slot. If the slot, i.e. the complete slot, has no PRB scheduled, then the antenna branches may be muted for the complete slot.

In an example scenario, a symbol in the slot has one or more PRBs scheduled, then the RU 111 may check a further parameter, that is the beam identifier, received in the C-plane message from the DU 112. The beam identifier maps to a specific beam weight table present at RU 111. This table at RU 111 comprises the beam weights associated for each antenna branch. Based on this, the RU 111 is enabled to handle energy saving by deciding whether or not an antenna branch shall be muted, by deciding that if a beam weight for an antenna branch is 0, then that antenna branch will be muted.

In another example scenario, the RU 111 received an identifier of a specific upcoming data stream, also referred to as the second data stream herein, but no C-plane message was received at RU 111, i.e., nothing is scheduled for the slot for the specific data stream, then the antenna branches for that stream may be muted.

So, if there is nothing to transmit for an antenna branch in an UL or DL slot, then the power amplifier for that antenna branch may be muted, e.g., switched off.

A number of embodiments will now be described, some of which may be seen as alternatives, while some may be used in combination.

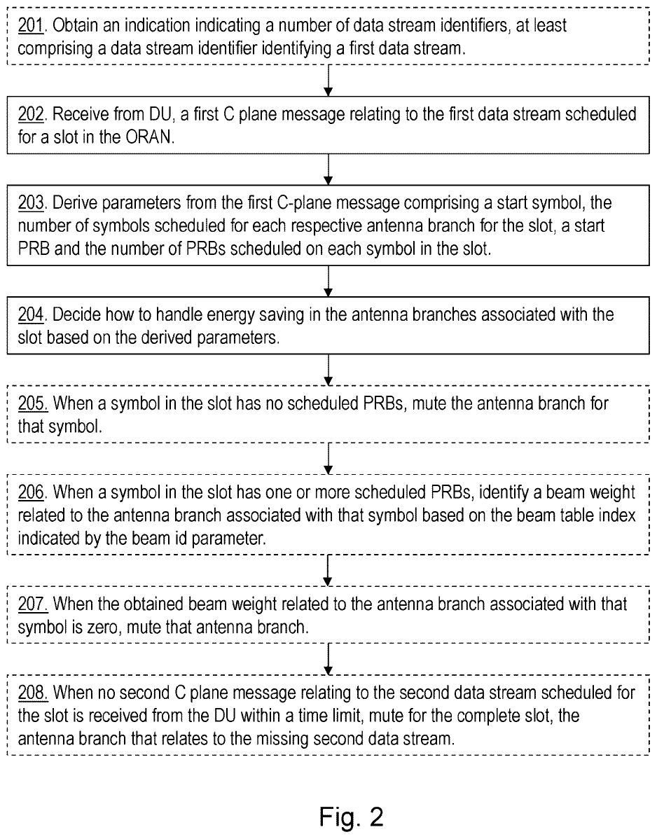

FIG. 2 shows example embodiments of a method performed by the RU 111. The method is for handling energy saving in antenna branches related to the RU 111. The RU 111 operates in the ORAN 102 comprised in the wireless communications network 100. An antenna branch is a physical antenna present on RU to transmit/receive air interface messaged to/from UE. E.g., a number of antenna branches are related to the RU 111, which may mean that they are associated to, comprised in, and/or used by the RU 111.

The method comprises the following actions, which actions may be taken in any suitable order. Optional actions are referred to as dashed boxes in FIG. 2.

### Action 201

There may be a number of data streams scheduled for a slot to be sent and/or received over the antenna branches between the RU 111 and the UE 120. The slot may be an UL slot or a DL slot. In some embodiments, the DU 112 informs the RU 111 about the scheduled data streams. The RU 110 may obtain an indication from the DU 112. The indication is indicating a number of data stream identifiers. Each data stream identifier identifies a data stream scheduled for the slot. The number of data stream identifiers at least comprises a data stream identifier identifying a data stream.

According to an example scenario, the number of data stream identifiers may further comprise a data stream identifier identifying another data stream, referred to as a second data stream.

The data stream and the second data stream are e.g., to be sent between the DU 112 and the RU 111 and be forwarded to the UE 120 by means of the antenna branches of the RU 111.

By e.g., an M-plane configuration, the DU 112 and the RU 111 knows how many antenna branches are configured and the unique identifier for each antenna branch. The intention may be to identify the number of data streams and that information may be present in an M plane message used to configure the cell. Each data stream has a unique identifier which is configured and exchanged between DU and RU, such as the DU 112 and the RU 111, in the M-plane message to form a mapping at DU and RU. This mapping may be used when a C-plane message is received at the RU 111 to identify the data stream for which this C plane message have been received at RU 111.

### Action 202

The RU 110 receives a C plane message from the DU 112. The C plane message relates to the data stream scheduled for a slot in the ORAN.

The unique identifiers exacId and RtcId, as specified by 3GPP, may be used to identify which data stream that the C-plane message maps to for a slot in the ORAN. The data stream maps to an antenna comprising the antenna branches of the RU 111.

### Action 203

The RU 110 then derives parameters from the C-plane message. The derived parameters comprise a start symbol and the number of symbols scheduled for each respective antenna branch for the slot. Since the C-plane message from the DU 112 is per antenna branch, so a combination of start symbol and number of symbols gives an indication of how many symbols are scheduled for a specific antenna branch. The derived parameters further comprise a start PRB and the number of PRBs scheduled on each symbol in the slot. This parameter information provides the specific symbols scheduled for a particular antenna branch in a slot and the number of PRBs on each symbol.

In some embodiments, the derived parameters further comprise a beam identifying parameter indicating which beam table index to be used to identify a beam weight for each respective antenna branch associated with the symbol in the slot. A beam weight when used herein may e.g. be used to identify if the antenna branch will be used to transmit signal or not, in case the beam weight associated with an antenna branch is 0 then that antenna branch will not be used.

In some embodiments, the derived parameters further comprise a parameter indicating the number of sections in the slot. The number of sections is used to combine the scheduling information of a symbol spread across a C plane message.

### Action 204

The RU 110 then decides how to handle energy saving in the antenna branches associated with the slot, based on the derived parameters. E.g., by using the derived parameter information the RU 111 is capable of identifying any antenna branches that will not be used for transmitting or receiving data related to the antenna branch. The RU 110 may then handle the energy saving in the antenna branches associated with the slot, by deciding to mute any of these identified antenna branches. Different example scenarios of how to handle the energy saving are described below in actions 205-208 below and will be exemplified further below.

As mentioned above, the derived parameters may further comprise a parameter indicating the number of sections in the slot. In these embodiments, the RU 111 decides of how to handle energy saving in the antenna branches associated with the slot based on the derived parameters for all sections out of the number of sections in the slot.

### Action 205

The deciding of how to handle energy saving in the antenna branches associated with the slot based on the derived parameters may comprise the following: When a symbol in the slot has no scheduled PRBs, the RU 110 mutes the antenna branch for that symbol. Thus, e.g. the receiver circuit for that antenna branch will be switched off.

### Action 206

As mentioned above, the derived parameters may further comprise a beam identifying parameter indicating which beam table index to be used to identify a beam weight for each respective antenna branch associated with the symbol in the slot.

In these embodiments, the deciding of how to handle energy saving in the antenna branches associated with the slot based on the derived parameters may further comprise the following: When a symbol in the slot has one or more scheduled PRBs, the RU 111 identifies a beam weight related to the antenna branch associated with that symbol based on the beam table index indicated by the beam id parameter. The antenna branch associated with “that symbol” here means the antenna branch associated with the symbol in the slot that has one or more scheduled PRBs.

### Action 207

When the obtained beam weight related to the antenna branch associated with that symbol is zero, the RU 111 may mute that antenna branch. Again, the antenna branch associated with “that symbol” here means the antenna branch associated with the symbol in the slot that has one or more scheduled PRBs. Thus, e.g. the receiver circuit for that antenna branch will be switched off.

So even if a symbol in the slot has one or more scheduled PRBs, an antenna branch may be muted if the beam identifying parameter indicates that the beam weights for that antenna branch is 0.

Action 208 When no second C plane message relating to a second data stream scheduled for the slot is received from the DU 112 within a time limit, the RU 111 may mute for the complete slot, the antenna branch that relates to the missing second data stream. Thus, e.g. the receiver circuit for that antenna branch will be switched off.

E.g., the RU 111 will wait for C plane message(s) up to a certain configured duration. The configuration may arrive at the RU 112 e.g., in an M-plane message for all configured antenna branches. Incase a C-plane message(s) doesn't arrive at the RU 112 in stipulated time, the RU may mute all the configured antenna branches for the slot for which C-plane message(s) was missed.

Embodiments herein such as the embodiments mentioned above will now be further described and exemplified. The text below is applicable to and may be combined with any suitable embodiment described above.

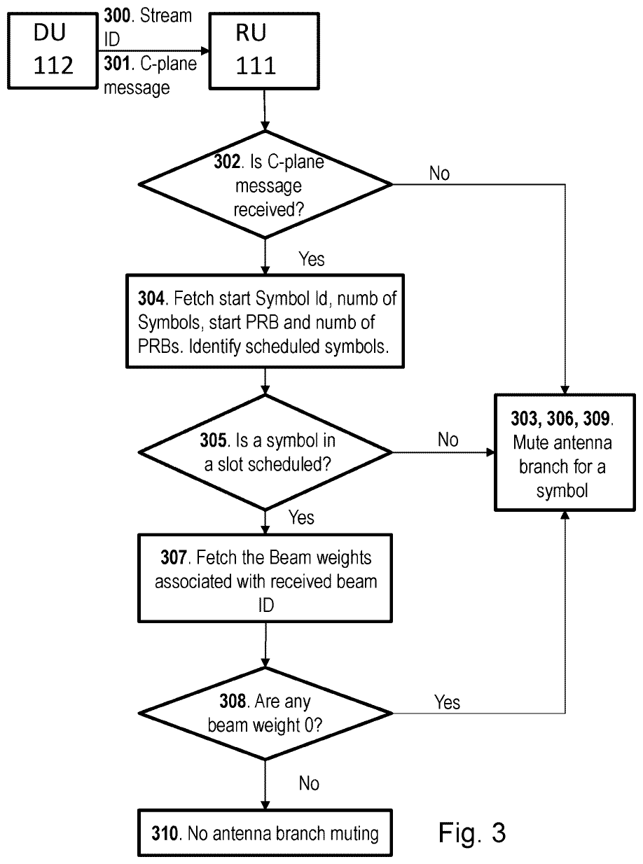

Steps of an example execution according to some embodiments herein are depicted in FIG. 3:
300. By e.g., an M-plane configuration, the DU 112 and the RU 111 knows how many antenna branches are configured and the unique identifier for each antenna branch.
301. The DU 112 sends a C-plane message to the RU 111 when the stream is scheduled for a slot.

If no data is scheduled for a slot, no C-plane message is sent to the RU 111.
302. The RU 111 checks if any C-plane message is received for the data stream identified by the received stream ID.
303. If NO, the RU 111 does not receive any C-plan message, corresponding antenna branches will be muted for all the symbols in the slot.
304. If YES, the RU 111 receives a C-plane message for the indicated stream ID, the RU 111 fetches the parameters: Start Symbol Id, number of Symbols, Start PRB and number of PRBs.
305. The RU 111 checks the fetched parameters to identify: Does a symbol in the slot comprise one or more scheduled PRBs.
306. If NO, at least one specific symbol in the slot does not comprise any scheduled PRBs. Then the RU 111 mutes the antenna branch corresponding to the at least one specific symbol.
307. If YES, at least one symbol in the slot comprises at least one scheduled PRB, the RU 111 will identify a beam weight, e.g. by fetching a beam weight corresponding to the beam identifying parameter comprised in the received C-plane message.
308. The RU 111 then checks if the beam weight is zero.
309. If YES, the beam weight is zero, the RU 111 mutes the antenna branch corresponding to that beam weight.
310. If NO, the beam weight is not zero, the antenna branch corresponding to that beam weight is not muted.

### Example 1

In example 1 of embodiments herein, a C-plane message comprises the following parameters indications:
Start Symbol Identifier: 0
Number of symbols: 4
Start PRB: 0
Number of PRBs: 50

Start Symbol Identifier:=0 means that the PRBs are scheduled from symbol 0. Start PRB=0 means that PRB allocation for each symbol starts from PRB 0.

In this example of embodiments herein, the C-plane message received by the RU 111 indicates that for a slot, 4 symbols are scheduled with 50 PRBs on each symbol starting from symbol 0 and PRB 0.

As specified in the 3GPP specification the total number of symbols for the slot is 14. Since only 4 symbols are scheduled with PRBs, the antenna branches relating to the remaining 10 symbols not scheduled with PRBs, will be muted.

### Example 2

In example 2 of embodiments herein, a C-plane message comprises the following parameters indications:
Start Symbol Identifier: 0
Number of symbols: 14
Start PRB: 0
Number of PRBs: 50
Beam Identifier: 6→BW[4]={1,1,0,1}

As specified in the 3GPP specification the total number of symbols for the slot is 14. Further, the C-plane message indicates that for slot, all 14 symbols are scheduled with 50 PRBs on each symbol. However, beam identifier: 6 indicates: BW[4]={1,1,0,1}, which means that in a 4 Transmitter 4 Receiver (4T4R) radio of the RU 111, the 3rd antenna branch has beam weight of zero. This information is used by the RU 111 to decide how to handle energy saving in the antenna branches associated with the slot. In this example the RU 111 mutes the 3rd antenna branch, e.g. by switching off the 3rd antenna branch circuit to save power.

In this example totally 1 antenna branches may be muted. This will save a lot of energy.

### Example 3

In example 3 of embodiments herein, no C-plane message is received for the second data stream, e.g., identified as Stream Identity 2, with in the time limit. This indicates that nothing is scheduled for the second data stream, in the slot. Hence the antenna branch mapped to the second data stream may be muted by the RU 111. So in this example a lot of energy will be saved.

To perform the method actions above, the RU 111 configured to handle energy saving in antenna branches related to the RU 111. The RU 111 is operable in the ORAN 102 of the wireless communications network 100.

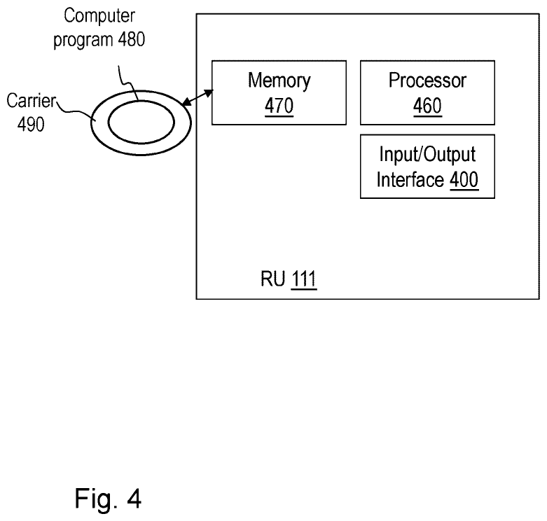

The RU 111 may comprise an arrangement depicted in FIG. 4. The the RU 111 may comprise an input and output interface 400 configured to communicate in the wireless communications network 100, e.g., with the DU 112. The input and output interface 400 may comprise a wireless receiver not shown, and a wireless transmitter not shown.

The RU 111 is further configured to,
Receive a Control, C, plane message from a Distributed Unit, DU, 112, which C plane message is adapted to relate to a data stream scheduled for a slot in the ORAN,
derive parameters from the C-plane message, which derived parameters are adapted to comprise: the start symbol and the number of symbols adapted to be scheduled for each respective antenna branch for the slot, and the start Physical Resource Block, PRB, and the number of PRBs adapted to be scheduled on each symbol in the slot, and
decide how to handle energy saving in the antenna branches associated with the slot, based on the derived parameters.

The RU 111 may further be configured to decide how to handle energy saving in the antenna branches associated with the slot based on the derived parameters by:
when a symbol in the slot has no scheduled PRBs, mute the antenna branch for that symbol.

In some embodiments, the derived parameters further are adapted to comprise a beam identifying parameter indicating which beam table index to be used to identify a beam weight for each respective antenna branch associated with the symbol in the slot.

In these embodiments, the RU 111 may further be configured to decide how to handle energy saving in the antenna branches associated with the slot based on the derived parameters by:
When a symbol in the slot has one or more scheduled PRBs, identify a beam weight related to the antenna branch associated with that symbol based on the beam table index indicated by the beam id parameter, and
when the obtained beam weight related to the antenna branch associated with that symbol is zero, mute that antenna branch.

The RU 111 may further be configured to:
Obtain from the DU 112, an indication indicating a number of data stream identifiers, wherein each data stream identifier is adapted to identify a data stream scheduled for the slot, wherein the number of data stream identifiers at least is adapted to comprises a data stream identifier identifying the data stream.

In some embodiments, the indication adapted to indicate the number of data stream identifiers, further is adapted to comprise a data stream identifier identifying a second data stream.

In these embodiments, the RU 111 may further be configured to:
When no second C plane message relating to a second data stream scheduled for the slot is received from the DU (112) within a time limit, mute for the complete slot, the antenna branch that relates to the missing second data stream.

In some embodiments, the derived parameters further are adapted to comprise a parameter indicating the number of sections in the slot. In these embodiments, the RU 111 may further be configured to decide of how to handle energy saving in the antenna branches associated with the slot by basing it on the derived parameters for all sections out of the number of sections in the slot.

The embodiments herein may be implemented through a respective processor or one or more processors, such as a processor 460 of a processing circuitry in the the RU 111 depicted in FIG. 4, together with computer program code for performing the functions and actions of the embodiments herein. The program code mentioned above may also be provided as a computer program product, for instance in the form of a data carrier carrying computer program code for performing the embodiments herein when being loaded into the RU 111. One such carrier may be in the form of a CD ROM disc. It is however feasible with other data carriers such as a memory stick. The computer program code may furthermore be provided as pure program code on a server and downloaded to the RU 111.

The RU 111 may further comprise a memory 470 comprising one or more memory units. The memory 470 comprises instructions executable by the processor in the RU 111. The memory 470 is arranged to be used to store e.g., information, indications, data, configurations, iterations, communication data, and applications to perform the methods herein when being executed in the RU 111.

In some embodiments, a computer program 480 comprises instructions, which when executed by the at least one processor 460, cause the at least one processor of the RU 111 to perform the actions above.

In some embodiments, a carrier 490 comprises the computer program 480, wherein the carrier 490 is one of an electronic signal, an optical signal, an electromagnetic signal, a magnetic signal, an electric signal, a radio signal, a microwave signal, or a computer-readable storage medium.

Those skilled in the art will appreciate that the arrangement in the RU 111 described above may refer to a combination of analog and digital circuits, and/or one or more processors configured with software and/or firmware, e.g. stored in the RU 111, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a System-on-a-Chip (SoC).

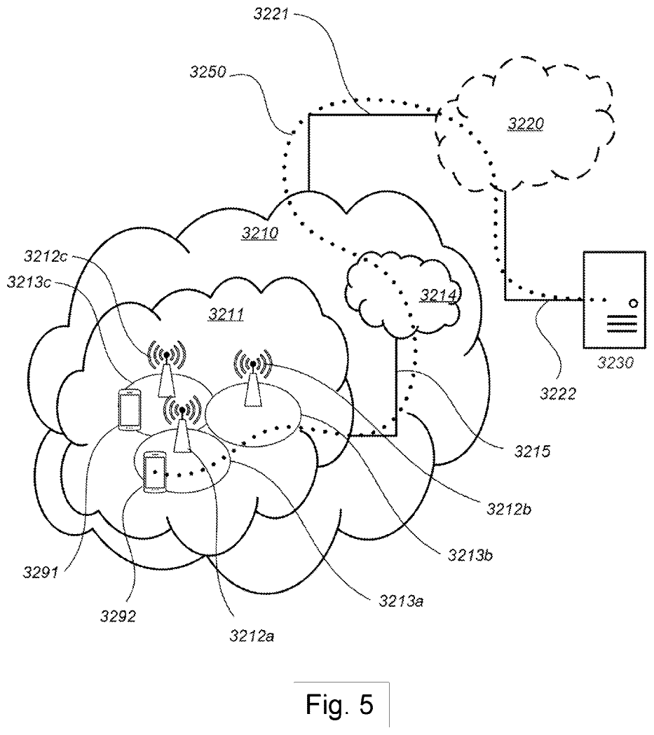

With reference to FIG. 5, in accordance with an embodiment, a communication system includes a telecommunication network 3210, such as a 3GPP-type cellular network, e.g. wireless communications network 100, which comprises an access network 3211, such as a radio access network, and a core network 3214. The access network 3211 comprises a plurality of base stations 3212a, 3212b, 3212c, e.g., the network node 110, the RU 111 or DU 112, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE), e.g. the UE 120, such as a Non-AP STA 3291 located in coverage area 3213c is configured to wirelessly connect to, or be paged by, the corresponding base station 3212c, e.g., the network node 110. A second UE 3292, e.g., any of the one or more second UEs 122, such as a Non-AP STA in coverage area 3213a is wirelessly connectable to the corresponding base station 3212a, e.g., the network node 110. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 5 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

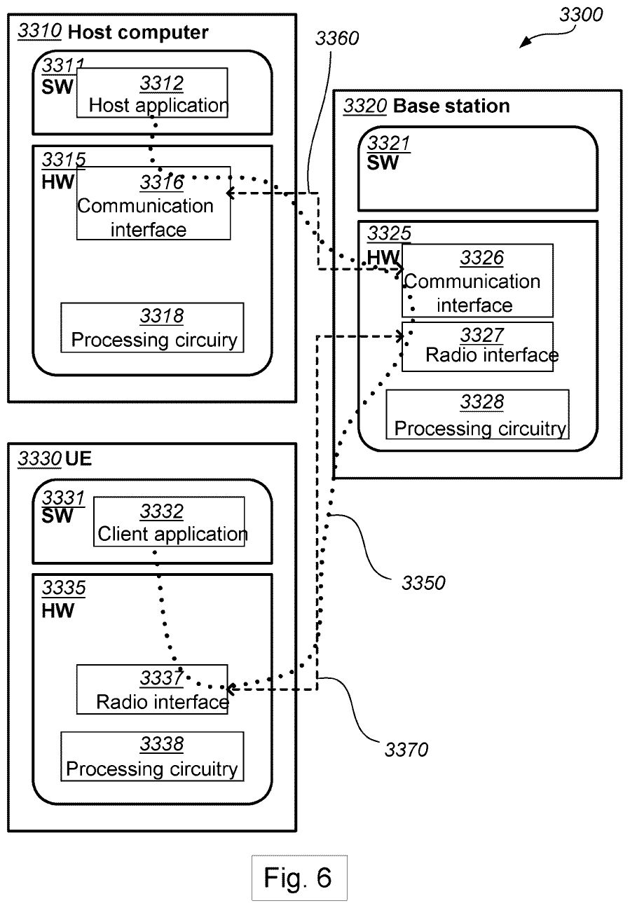

Example implementations, in accordance with an embodiment, of the UE, base station and host computer discussed in the preceding paragraphs will now be described with reference to FIG. 6. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 6) served by the base station 3320. The communication interface 3326 may be configured to facilitate a connection 3360 to the host computer 3310. The connection 3360 may be direct or it may pass through a core network (not shown in FIG. 6) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 5 may be identical to the host computer 3230, one of the base stations 3212a, 3212b, 3212c and one of the UEs 3291, 3292 of FIG. 5, respectively. This is to say, the inner workings of these entities may be as shown in FIG. 6 and independently, the surrounding network topology may be that of FIG. 5.

In FIG. 6, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as e.g. the applicable corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc. ; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

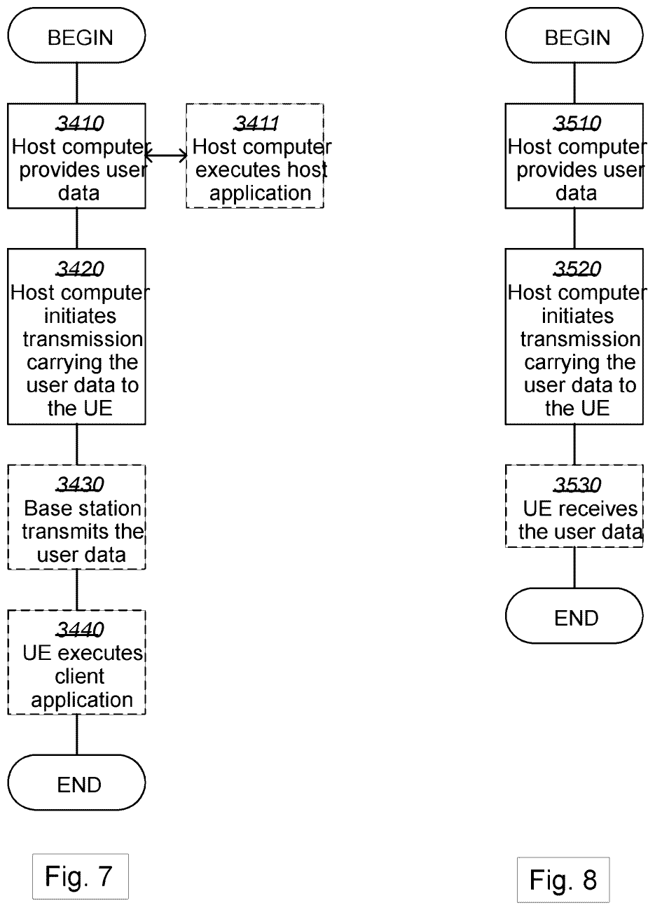

FIG. 7 is a flowchart illustrating a method implemented in a communication system, in accordance with one embodiment. The communication system includes a host computer, a base station such as an AP STA, and a UE such as a Non-AP STA which may be those described with reference to FIG. 5 and FIG. 6. For simplicity of the present disclosure, only drawing references to FIG. 7 will be included in this section. In a first step 3410 of the method, the host computer provides user data. In an optional sub step 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 8 is a flowchart illustrating a method implemented in a communication system, in accordance with one embodiment. The communication system includes a host computer, a base station such as an AP STA, and a UE such as a Non-AP STA which may be those described with reference to FIG. 5 and FIG. 6. For simplicity of the present disclosure, only drawing references to FIG. 8 will be included in this section. In a first step 3510 of the method, the host computer provides user data. In an optional sub step (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

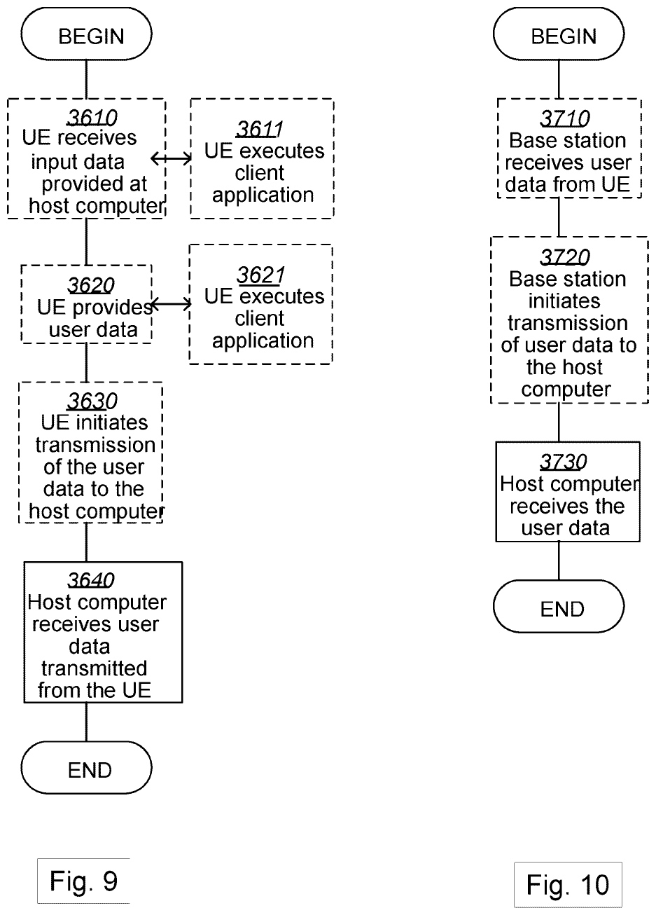

FIG. 9 is a flowchart illustrating a method implemented in a communication system, in accordance with one embodiment. The communication system includes a host computer, a base station such as an AP STA, and a UE such as a Non-AP STA which may be those described with reference to FIG. 5 and FIG. 6. For simplicity of the present disclosure, only drawing references to FIG. 9 will be included in this section. In an optional first step 3610 of the method, the UE receives input data provided by the host computer. Additionally or alternatively, in an optional second step 3620, the UE provides user data. In an optional sub step 3621 of the second step 3620, the UE provides the user data by executing a client application. In a further optional sub step 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub step 3630, transmission of the user data to the host computer. In a fourth step 3640 of the method, the host computer receives the user data transmitted from the UE, in accordance with the teachings of the embodiments described throughout this disclosure.

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 5 and FIG. 6. For simplicity of the present disclosure, only drawing references to FIG. 10 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

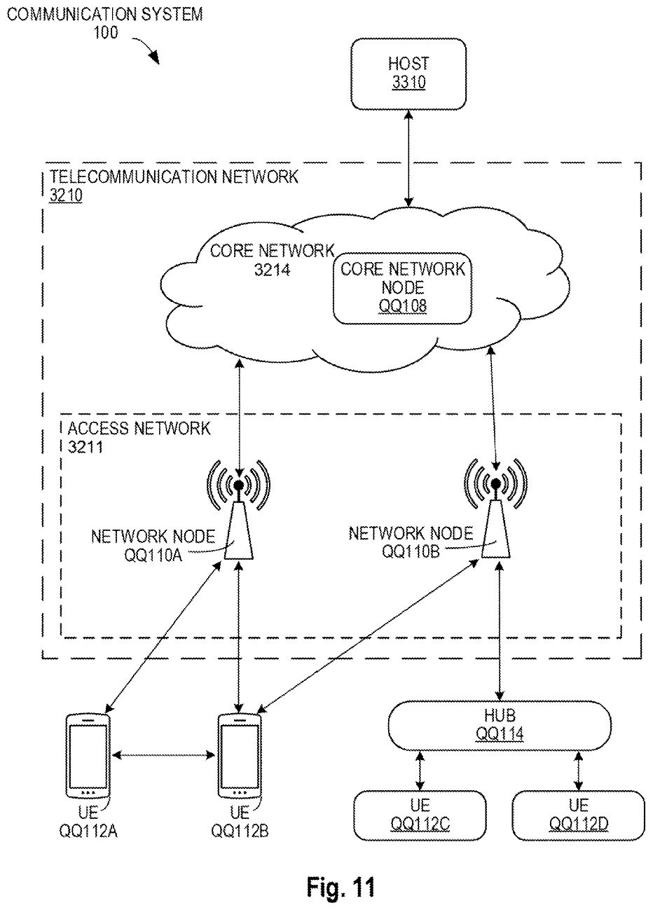

For example, in some embodiments, the telecommunication network 3210 includes one or more Open-RAN (ORAN) network nodes, as depicted in FIG. 11. An ORAN network node is a node in the telecommunication network 3210 that supports an ORAN specification (e.g., a specification published by the O-RAN Alliance, or any similar organization) and may operate alone or together with other nodes to implement one or more functionalities of any node in the telecommunication network 3210, including one or more network nodes, QQ110 and/or core network nodes QQ108.

Examples of an ORAN network node include an open radio unit (O-RU), such as e.g. the RU 111, an open distributed unit (O-DU) such as e.g. the DU 112, an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network 3214 over one or more wireless connections.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

1. A method performed by a Radio Unit, RU, for handling energy saving in antenna branches related to the RU, which RU operates in an Open Radio Access Network, ORAN, of a wireless communications network the method comprising:
receiving a Control, C, plane message from a Distributed Unit, DU, which C plane message relates to a data stream scheduled for a slot in the ORAN,
deriving parameters from the C-plane message, which derived parameters comprise: a start symbol and the number of symbols scheduled for each respective antenna branch for the slot, and a start Physical Resource Block, PRB, and the number of PRBs scheduled on each symbol in the slot, and
deciding how to handle energy saving in the antenna branches associated with the slot, based on the derived parameters.

2. The method according to claim 1, wherein the deciding of how to handle energy saving in the antenna branches associated with the slot based on the derived parameters comprises:
when a symbol in the slot has no scheduled PRBs, muting the antenna branch for that symbol.

3. The method according to claim 1, wherein the derived parameters further comprise a beam identifying parameter indicating which beam table index to be used to identify a beam weight for each respective antenna branch associated with the symbol in the slot, and wherein the deciding of how to handle energy saving in the antenna branches associated with the slot based on the derived parameters further comprises:
when a symbol in the slot has one or more scheduled PRBs, identifying a beam weight related to the antenna branch associated with that symbol based on the beam table index indicated by the beam id parameter, and
hen the obtained beam weight related to the antenna branch associated with that symbol is zero, muting that antenna branch.

4. The method according to claim 1, further comprising:
obtaining from the DU, an indication indicating a number of data stream identifiers, wherein each data stream identifier identifies a data stream scheduled for the slot, wherein the number of data stream identifiers at least comprises a data stream identifier identifying the data stream.

5. The method according to claim 4, further comprising:
when no second C plane message relating to a second data stream scheduled for the slot is received from the DU within a time limit, muting for the complete slot, the antenna branch that relates to the missing second data stream.

6. The method according to claim 1, wherein the derived parameters further comprise a parameter indicating the number of sections in the slot, and wherein the deciding of how to handle energy saving in the antenna branches associated with the slot is based on the derived parameters for all sections out of the number of sections in the slot.

7. A computer-readable storage medium, having stored thereon a computer program comprising instructions, which when executed by a computer processor, causes the computer processor to carry out the steps of the method according to claim 1.

8. (canceled)

9. A Radio Unit, RU, configured to handle energy saving in antenna branches related to the RU which RU is operable in an Open Radio Access Network, ORAN, of a wireless communications network the RU further being configured to:
receive a Control, C, plane message from a Distributed Unit, DU, which C plane message is adapted to relate to a data stream scheduled for a slot in the ORAN,
derive parameters from the C-plane message, which derived parameters are adapted to comprise: a start symbol and the number of symbols adapted to be scheduled for each respective antenna branch for the slot, and a start Physical Resource Block, PRB, and the number of PRBs adapted to be scheduled on each symbol in the slot, and
decide how to handle energy saving in the antenna branches associated with the slot, based on the derived parameters.

10. The RU according to claim 9, further being configured to decide how to handle energy saving in the antenna branches associated with the slot based on the derived parameters by:
when a symbol in the slot has no scheduled PRBs, mute the antenna branch for that symbol.

11. The RU according to claim 9, wherein the derived parameters further are adapted to comprise a beam identifying parameter indicating which beam table index to be used to identify a beam weight for each respective antenna branch associated with the symbol in the slot, and wherein the RU further is configured to decide how to handle energy saving in the antenna branches associated with the slot based on the derived parameters by:
when a symbol in the slot has one or more scheduled PRBs, identify a beam weight related to the antenna branch associated with that symbol based on the beam table index indicated by the beam id parameter, and
when the obtained beam weight related to the antenna branch associated with that symbol is zero, mute that antenna branch.

12. The RU according to claim 9, further being configured to:
obtain from the DU, an indication indicating a number of data stream identifiers, wherein each data stream identifier is adapted to identify a data stream scheduled for the slot, wherein the number of data stream identifiers at least is adapted to comprise a data stream identifier identifying the data stream.

13. The RU according to claim 12, further being configured to:
when no second C plane message relating to a second data stream scheduled for the slot is received from the DU within a time limit, mute for the complete slot, the antenna branch that relates to the missing second data stream.

14. The RU according to claim 9, wherein the derived parameters further are adapted to comprise a parameter indicating the number of sections in the slot, and wherein the RU further is configured to decide how to handle energy saving in the antenna branches associated with the slot by basing it on the derived parameters for all sections out of the number of sections in the slot.
